(19) United States
(12) Patent Application Publication
(10) Pub. No.: US 2007/0002192 A1
(43) Pub. Date: Jan. 4, 2007

(54) Liquid crystal display apparatus including touch panel

(75) Inventors: Toshiharu Nishino, Hamura-shi (JP); Hidehiro Morita, Hachioji-shi (JP); Kunpei Kobayashi, Tachikawa-shi (JP); Makoto Iwasaki, Akishima-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 11/475,620

(22) Filed: Jun. 27, 2006

(30) Foreign Application Priority Data
Jun. 29, 2005 (JP) 2005-189855
Dec. 20, 2005 (JP) 2005-366545
Dec. 21, 2005 (JP) 2005-368291

(51) Int. Cl. G02F 1/1335

(52) U.S. Cl. 349/12

(57) ABSTRACT

A liquid crystal display apparatus includes a liquid crystal display device and a touch panel. The display device includes first and second substrates positioned on observation and opposite sides, respectively, a liquid crystal layer interposed between the substrates, a first electrode provided on one of opposed inner surface sides of the substrates, a second electrode provided on an inner surface side of one of the substrates and supplies a voltage between itself and the first electrode to apply an electric field to the liquid crystal layer, and two polarizing plates respectively arranged on the observation and opposite sides on the other side of the substrates. The touch panel includes an electroconductive film arranged on an outer surface of the substrate or the polarizing plate on the observation side, and detects a specified position on the electroconductive film based on a voltage previously applied thereto and a voltage measured at the specified position.

### CROSS-REFERENCE TO RELATED APPLICATIONS

This application is based upon and claims the benefit of priority from prior Japanese Patent Applications No. 2005-189855, filed Jun. 29, 2005; No. 2005-366545, filed Dec. 20, 2005; and No. 2005-368291, filed Dec. 21, 2005, the entire contents of all of which are incorporated herein by reference.

### BACKGROUND OF THE INVENTION

1. Field of the Invention

The present invention relates to a liquid crystal display apparatus having a touch panel provided on a front surface of a liquid crystal display device.

2. Description of the Related Art

There is known a liquid crystal display apparatus having a touch panel for touch input arranged on a front surface of a liquid crystal display device. This touch panel has a structure in which a pair of sheets each having a transparent resistance film formed on one surface of a transparent substrate formed of a glass sheet or a resin film are arranged in such a manner their respective resistance films face each other with a gap therebetween (e.g., Jpn. Pat. Appln. KOKAI Publication No. 2000-163208).

In this touch panel, assuming that the outer surface of one of the pair of sheets is a touch surface, when an arbitrary position on the touch surface is touched by a touch pen or the like, a part of one sheet mentioned above corresponding to a touched position is flexibly deformed, and the resistance film on one sheet comes into contact with the resistance film on the other sheet. At this time, a voltage is alternately applied between both ends of one resistance film in one direction and between both ends of the other resistance film in a direction perpendicular to one direction, and a voltage value at one end of one resistance film and a voltage value at one end of the other resistance film are measured, respectively. As a result, coordinates of the touched point in one direction and the direction perpendicular to this direction can be detected.

In contrast, as a liquid crystal display device on which a touch panel is arranged, there is known a transverse electric filed control type having a structure in which a liquid crystal is sealed between a pair of an observation-side substrate and an opposite-side substrate facing each other with a gap therebetween, and first and second display electrodes are provided on one of inner surfaces of the pair of substrates facing each other. The first and second display electrodes being insulated from each other and supplying a display drive voltage between themselves to generate a transverse electric field in a direction substantially parallel to the substrate surfaces (e.g., Jpn. Pat. Appln. KOKAI publication No. 159996-1997 and Jpn. Pat. Appln. KOKAI Publication No. 202356-1999).

This transverse electric field control type liquid crystal display device supplies a display drive voltage corresponding to image data between the first and second display electrodes on the inner surface of one substrate, and controls an alignment direction of liquid crystal molecules (a direction of molecular long axes) within a plane substantially parallel to the substrate surfaces by using a transverse electric field generated between the display electrodes, thereby displaying an image. This transverse electric field control type liquid crystal display device has a wide viewing angle.

The touch panel has a structure in which a pair of resistance film sheets each having a resistance film formed on one surface of a transparent substrate are arranged in such a manner that their respective resistance film formed surfaces face each other with a gap therebetween, and has a thickness obtained by adding a height of the gap between these resistance film sheets to thicknesses of the pair of resistance film sheets. Therefore, the liquid crystal display device having the touch panel arranged on the observation side has a problem that the total thickness including the touch panel is large.

On the other hand, the transverse electric field control type liquid crystal display device also has a problem that display becomes unstable when an electrical-charged matter such as a finger touches or moves close to the observation-side surface because static electricity applied from the observation side greatly affects control over an alignment direction of liquid crystal molecules based on a transverse electric field.

### BRIEF SUMMARY OF THE INVENTION

It is an object of the present invention to provide a liquid crystal display apparatus which is provided with a touch panel and whose thickness including the touch panel can be reduced.

Further, it is another object of the present invention to provide a liquid crystal display apparatus which can perform stable display which is not affected by static electricity from an observation side and whose structure is simplified to reduce the thickness thereof.

According to a first aspect of the present invention, there is provided a liquid crystal display apparatus comprising:

a liquid crystal display device; and

a touch panel,

the liquid crystal display device including:

first and second substrates which are arranged to face each other with a gap therebetween, the first substrate being positioned on an observation side and the second substrate being positioned on an opposite side of the observation side where the first substrate is positioned;

a liquid crystal layer interposed between the first and second substrates;

a first electrode which is provided on one of opposed inner surface sides of the substrates, and a second electrode which is provided on an inner surface side of one of the first and second substrates and supplies a voltage between itself and the first electrode to apply an electric field to the liquid crystal layer; and

a pair of polarizing plates respectively arranged on the observation side and the opposite side on the other side of the substrates,

the touch panel having at least one first electroconductive film which is arranged on at least one of an outer surface of the substrate and the polarizing plate on the observation side in the liquid crystal display device and has a predetermined resistance value, and detecting a specified position on the first electroconductive film based on a voltage previously applied to the first electroconductive film and a voltage measured at the specified position.

The touch panel may comprise: means for applying a predetermined voltage to the first electroconductive film; means for measuring a voltage at the specified position on the first electroconductive film; and position detecting means for detecting the specified position based on a value of the measured voltage.

The touch panel is preferably formed of a contact type touch panel adopting a resistance mode which includes a second electroconductive film arranged to face the first electroconductive film with a gap therebetween, and deforms the second electroconductive film by locally pushing the second electroconductive film from the observation side, whereby the pushed part of the second electroconductive film is locally brought into contact with the first electroconductive film.

The touch panel may comprise: a second electroconductive film arranged to face the first electroconductive film with a gap therebetween; means for supplying a voltage to the first and second electroconductive films; means for measuring a voltage at the specified position on the first electroconductive film and a voltage at the specified position on the second electroconductive film, respectively; and means for detecting the specified position based on values of the plurality of measured voltages.

The first electroconductive film of the touch panel is preferably provided on an outer surface of the observation-side substrate in the liquid crystal display device. The liquid crystal display device may comprise an observation-side polarizing plate arranged on the observation side on the outer side of the substrates with a predetermined gap, and the second electroconductive film of the touch panel is formed on a surface of the observation-side polarizing plate facing the observation-side substrate.

Preferably, the liquid crystal display device further comprises an optical film having a phase plate which is arranged on the observation side of the observation-side substrate with a predetermined gap and optically compensates transmitted light, and the second electroconductive film of the touch panel is formed on a surface of the optical film facing the observation-side substrate.

The liquid crystal display apparatus according to claim 5, wherein the liquid crystal display device further comprises an optical film having of a phase plate which is arranged between the observation-side substrate and the observation-side polarizing plate and optically compensates transmitted light, and the touch panel further comprises a transparent protection film which is arranged on the first electroconductive film provided on the observation side of the observation-side substrate in the liquid crystal display device with a predetermined gap therebetween and has the second electroconductive film formed on its surface facing the first electroconductive film.

The liquid crystal display device may comprise at least two of first and second electrodes which are formed on the inner surface side of one of substrates facing each other and apply a voltage between themselves to apply an electric field in a direction substantially parallel to the surfaces of the substrates to the liquid crystal layer, and a third electrode which is provided on the inner surface of the other substrate and applies an electric field in a thickness direction of the liquid crystal layer between itself and at least one of the first electrode and the second electrode.

According to a second aspect of the present invention, there is provided a liquid crystal display apparatus comprising:

a liquid crystal display device; and

a touch panel,

the liquid crystal display device having:

first and second substrates which are arranged to face each other with a gap therebetween, the first substrate being positioned on an observation side and the second substrate being positioned on an opposite side of the observation side where the first substrate is positioned;

a liquid crystal layer interposed between the first and second substrates;

a first electrode which is provided on one of opposed inner surfaces of the substrates, i.e., an inner surface of one substrate, and a second electrode which is provided on an inner surface of the one substrate or the other substrate and supplies a voltage between itself and the first electrode to apply an electric field to the liquid crystal layer; and

a pair of polarizing plates which are arranged on the observation side and the opposite side on the outer sides of the first and second substrates, respectively, the touch panel having:

a first electroconductive film which is provided on an outer surface of the first substrate in the liquid crystal layer and has a predetermined resistance value;

a second electroconductive film which is arranged to face the first electroconductive film with a gap therebetween, partially deformed to come into contact with the first electroconductive film when a specified position in a region corresponding to the first electroconductive film is pushed, and has a predetermined resistance value, a voltage being supplied to the first and second electroconductive films; and

position detecting means for measuring a voltage at a position where the first electroconductive film and the second electroconductive film come into contact with each other, and detecting the contact position on the first electroconductive film based on the measured voltage.

In the second aspect, the liquid crystal display device may comprise an observation-side polarizing plate arranged on the observation side on the outer side of the first and second substrates with a predetermined gap, and the second electroconductive film of the touch panel is provided on a surface of the observation-side polarizing plate facing the first substrate.

Preferably, the liquid crystal display device further comprises a film-like optical element which is arranged on the observation side of the first substrate with a predetermined gap and optically compensates transmitted light, and the second electroconductive film of the touch panel is formed on a surface of the optical element facing the first substrate.

The optical element is preferably formed of a phase plate which compensates the viewing angle dependence of a transmission factor of the liquid crystal display device. Also, the touch panel preferably further comprises a transparent protection film which is arranged on the observation side of the first substrate of the liquid crystal display device with a predetermined gap, and the second electroconductive film is formed on a surface of the protection film facing the first substrate.

The liquid crystal display device may be a liquid crystal display device in which first and second electrodes which generate an electric field in a thickness direction of the liquid crystal layer are respectively formed on opposed inner surfaces of the first and second substrates and an inclination of liquid crystal molecules in the liquid crystal layer with respect to the substrate surfaces is controlled to control a transmission factor. Alternately, the liquid crystal display device may be a transverse electric field type liquid crystal display device in which first and second electrodes which generate an electric field substantially parallel to surfaces of the first and second substrates are formed on one of opposed inner surfaces of the pair of substrates and an alignment direction of liquid crystal molecules in the liquid crystal layer is controlled within a plane parallel to the surfaces of the substrates to control a transmission factor. Alternately, the liquid crystal display device may be a viewing angle control type liquid crystal display device in which a third electrode is formed on the other one of opposed inner surfaces of the first and second substrates and an electric field is generated between the third electrode and at least one of the first and second electrodes to obliquely align the liquid crystal molecules with respect to the surfaces of the substrates, thereby controlling a viewing angle of the liquid crystal display device.

According to a third aspect of the present invention, there is provided a liquid crystal display apparatus comprising:

a liquid crystal display device; and

a touch panel,

the liquid crystal display device having:

first and second substrates which are arranged to face each other with a gap therebetween, the first substrate being positioned on an observation side and the second substrate being positioned on an opposite side of the observation side where the first substrate is positioned;

a liquid crystal layer interposed between the first and second substrates;

a first electrode provided on one of opposed inner surfaces of the first and second substrates, and a second electrode which is provided on an inner surface of the one substrate or the other substrate and supplies a voltage between itself and the first electrode to apply an electric field to the liquid crystal layer; and

a pair of polarizing plates respectively arranged on the observation side and the opposite side on the outer sides of the first and second substrates,

the touch panel having:

an electroconductive film which is arranged on the observation side of the liquid crystal display device and has a resistance value;

voltage applying means for supplying a voltage from both ends of the electroconductive film in one direction and both ends in the other direction crossing one direction;

means for specifying an arbitrary position on the electroconductive film; and

position detecting means for measuring a voltage at a position on the electroconductive film specified by the means for specifying the position, and detecting the specified position based on the measured voltage.

In the third aspect, the touch panel may comprise another electroconductive film formed on the observation side of a transparent film which is arranged on the observation side of the liquid crystal display device with a predetermined gap through a spacer. Alternately, the touch panel may comprise another electroconductive film formed on the observation side of a transparent film closely arranged on the observation-side polarizing plate in the liquid crystal display device.

liquid crystal display apparatus . . . claims 18-20.

In the liquid crystal display apparatus according to the first aspect of the present invention, at least one first electroconductive film is formed on at least one of the outer surface of the substrate and the polarizing plate on the observation side of the liquid crystal display device, and the touch panel which detects a specified position on the first electroconductive film based on a voltage previously applied to the first electroconductive film and a voltage measured at the specified position is formed, whereby a thickness including the touch panel can be reduced.

In the liquid crystal display apparatus according to the second aspect of the present invention, it is possible to reduce a total thickness of the liquid crystal display apparatus including the touch panel having: the first electroconductive film provided on the outer surface of the observation-side substrate of the liquid crystal display device; the second electroconductive film which is arranged to face the first electroconductive film with a gap therebetween and partially deformed to come into contact with the first electroconductive film by pressing a specified position in a region corresponding to the first electroconductive film; voltage supplying means for supplying a voltage to the first and second electroconductive films; and position detecting means for measuring a voltage of a position at which the first electroconductive film and the second electroconductive film come into contact with each other and detecting the contact position on the first electroconductive film based on the measured voltage.

Furthermore, when a transverse electric field type liquid crystal display device having the first and second electrodes formed on one of the pair of substrates is used as the liquid crystal display device of the liquid crystal display apparatus, stable display which is not affected by electrostatic electricity from the observation side can be performed, and it is possible to obtain the liquid crystal display apparatus with the touch panel whose structure is simplified to reduce a thickness thereof.

Since the liquid crystal display apparatus according to the third aspect of the present invention comprises: voltage applying means for respectively supplying voltages from both ends of the first electroconductive film in one direction and both ends in the other direction crossing one direction; means for specifying an arbitrary position on the electroconductive film; and position detecting means for measuring a voltage at a position on the electroconductive film specified by the means for specifying a position and detecting the specified position based on the measured voltage, a thickness of the liquid crystal display apparatus provided with the touch panel can be reduced.

### BRIEF DESCRIPTION OF THE SEVERAL VIEWS OF THE DRAWING

FIG. 1 is a cross-sectional view of a liquid crystal display apparatus according to a first embodiment of the present invention;

FIG. 2 is a schematic block diagram of touched position coordinate detecting means connected with a touch panel of the liquid crystal display device;

FIG. 3 is a cross-sectional view of a liquid crystal display apparatus according to a second embodiment of the present invention;

FIG. 4 is a cross-sectional view of a liquid crystal display apparatus according to a third embodiment of the present invention;

FIG. 5 is a cross-sectional view of a part of a liquid crystal display apparatus according to a fourth embodiment of the present invention;

FIG. 6 is a plan view of a part of one substrate of a liquid crystal display device depicted in FIG. 5;

FIG. 7 is a view showing aligning treatment directions of alignment films and directions of transmission axes of polarizing plates which are respectively provided on inner surfaces of a pair of substrates of the liquid crystal display device depicted in FIG. 5;

FIG. 8 is a schematic block diagram showing touched position coordinate detecting means connected with a touch panel of the liquid crystal display device depicted in FIG. 5;

FIGS. 9A and 9B schematically show an arrangement state of liquid crystal molecules when a vertical electric field and a transverse electric field are not applied to each pixel in the liquid crystal display device depicted in FIG. 5, wherein FIG. 9A is a cross-sectional view and FIG. 9B is a plan view;

FIGS. 10A and 10B schematically show an arrangement state of liquid crystal molecules when a vertical electric field is not applied to each pixel but a transverse electric field is applied to each pixel in the liquid crystal display device depicted in FIG. 5, wherein FIG. 10A is a cross-sectional view and FIG. 10B is a plan view;

FIGS. 11A and 11B schematically show an arrangement state of liquid crystal molecules when a vertical electric field is applied to each pixel and a transverse electric field is not applied to each pixel in the liquid crystal display device depicted in FIG. 4, wherein FIG. 11A is a cross-sectional view and FIG. 11B is a plan view;

FIGS. 12A and 12B schematically show an arrangement state of liquid crystal molecules when a vertical electric field and a transverse electric field are applied to each pixel in the liquid crystal display device depicted in FIG. 5, wherein FIG. 12A is a cross-sectional view and FIG. 12B is a plan view;

FIG. 13 is a cross-sectional view showing a part of a liquid crystal display apparatus according to a fifth embodiment of the present invention;

FIG. 14 is a plan view showing a part of one substrate of a liquid crystal display device depicted in FIG. 13;

FIG. 15 is a cross-sectional view showing a liquid crystal display apparatus according to a sixth embodiment of the present invention;

FIG. 16 is a plan view showing a touch panel depicted in FIG. 15;

FIG. 17 is a schematic block diagram showing touched position coordinate detecting means connected with the touch panel in the liquid crystal display apparatus depicted in FIG. 15;

FIG. 18 is a schematic block diagram showing a modification of the touched position coordinate detecting means connected with the touch panel in the liquid crystal display apparatus depicted in FIG. 15; and

FIG. 19 is a side view showing a modification according to a seventh embodiment of the present invention.

### DETAILED DESCRIPTION OF THE INVENTION

### First Embodiment

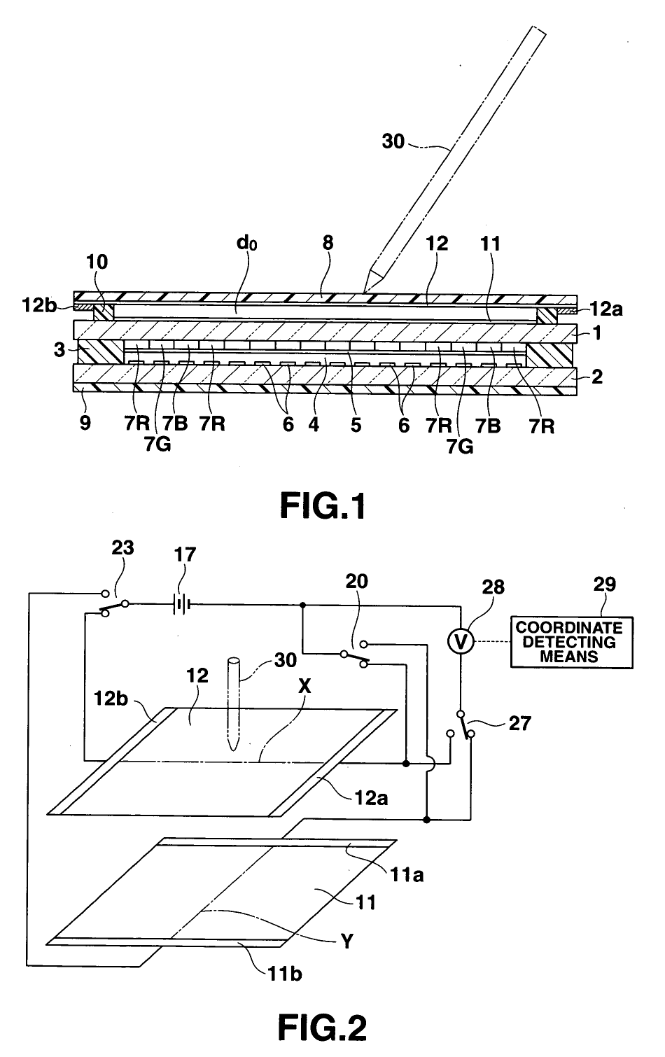

FIGS. 1 and 2 show a first embodiment of the present invention, wherein FIG. 1 is a cross-sectional view of a liquid crystal display device, and FIG. 2 is a schematic block diagram of touched position coordinate detecting means thereof.

As shown in FIG. 1, this liquid crystal display device has a pair of transparent substrates 1 and 2 on an observation side (an upper side in the drawing) and an opposite side which are jointed with each other through a frame-like sealing material 3. A liquid crystal layer 4 is sealed in a region surrounded by the sealing material 3 between these substrates 1 and 2. First and second transparent electrodes 5 and 6 which are respectively provided on opposed inner surfaces of the pair of substrates 1 and 2 to face each other and form a plurality of pixel regions in which the alignment state of liquid crystal molecules is controlled by applying an electric field to the liquid crystal layer 4. A pair of observation-side and opposite-side polarizing plates 8 and 9 are respectively arranged on outer surface sides of the observation-side and opposite-side substrates 1, 2.

This liquid crystal display device is of an active matrix liquid crystal display type in which a plurality of pixel electrodes 6 are arranged in a matrix form in a row direction and a column direction on the inner surface of one substrate, e.g., the substrate 2 on the opposite side of the observation side, and a single film-like opposed electrode 5 is provided on the inner surface of the other substrate, i.e., the observation-side substrate 1 to face arrangement regions of the plurality of pixel electrodes 6. Although not shown, in this liquid crystal display device, a plurality of thin-film transistors (TFTs) respectively connected with the plurality of pixel electrodes 6, a plurality of scanning lines which supply gate signals to the TFTs in each row and a plurality of data lines which supply data signals to the TFTs in each column are provided on the inner surface of one substrate (the opposite-side substrate) 2.

Color filters 7R, 7G and 7B of three colors, i.e., red, green and blue, are provided on the inner surface of the other substrate (the observation-side substrate) 1 in accordance with each of the plurality of pixels, and the opposed electrode 5 is formed on the color filters 7R, 7G and 7B.

Alignment films (not shown) are provided on the inner surface sides of the pair of substrates 1 and 2 to cover the electrodes 5 and 6, and liquid crystal molecules in the liquid crystal layer 4 are aligned in an alignment state which is defined by the alignment films between the substrates 1 and 2.

This liquid crystal display device is of one of a TN or STN type in which the liquid crystal molecules are twist-aligned, a homeotropic alignment type in which the liquid crystal molecules are substantially vertically aligned with respect to the surfaces of the substrates 1 and 2, a homogeneous alignment type in which the liquid crystal molecules are aligned in substantially parallel to the surfaces of the substrates 1 and 2 without twisting the liquid crystal molecules and a bend alignment type in which the liquid crystal molecules are bend-aligned. Alternatively, this liquid crystal display device may be a ferroelectric or antiferroelectric liquid crystal display device. The pair of polarizing plates 8 and 9 are arranged with their transmission axes set in relation to an alignment direction or the like of the liquid crystal molecules in order to obtain excellent contrast.

Of the pair of polarizing plates 8 and 9, the polarizing plate 9 on the opposite side of the observation side is attached on the outer surface of the opposite-side substrate 2, and the observation-side polarizing plate 8 is arranged to face the outer surface of the observation-side substrate 1 with a gap d0 therebetween. A rim portion of the first side polarizing plate 8 is supported by the observation-side substrate 1 through a frame-like spacer 10 which surrounds a screen region in which the plurality of pixels are arranged in a matrix form.

A first electroconductive film 11 which is constituted of one film-like transparent electroconductive film corresponding to all of the screen region and has a predetermined resistance value is formed on an outer surface of the observation-side substrate 1. A second electroconductive film 12 (is provided on an inner surface of the polarizing plate 8 facing the substrate 1.) The film 12 is constituted of a transparent electroconductive film and flexibly deformed together with the observation-side polarizing plate 8 to locally come into contact with the first electroconductive film 11 by a touch pressure locally applied to an outer surface of the polarizing plate 8 and which has a predetermined resistance value

Of the pair of substrates 1 and 2, at least the observation-side substrate 1 is formed of a transparent material, e.g., glass, and the first electroconductive film 11 is formed of a transparent film, e.g., an ITO film formed on the outer surface of the observation-side substrate.

A support of a polarization layer of at least the observation-side polarizing plate 8 of the pair of polarizing plates is constituted of a resin film made of triacetyl cellulose, optically isotropic polycarbonate, polyether sulfone or the like. The second electroconductive film 12 is constituted of a transparent film, e.g., an ITO film formed on an outer surface of the support of the observation-side polarizing plate 8.

Although not shown in FIG. 1, a plurality of columnar spacers (are preferably provided to protrude on one of these electroconductive films 11 and 12 along a column direction and a row direction with a predetermined pitch.) The spacers define a constant gap between the first and second electroconductive films 11 and 12 and are formed of an insulating material. As a result, the second electroconductive film 12 is apart from the first electroconductive film 11 in a state where no pressure is applied. When an arbitrary position on the outer surface of the observation-side polarizing plate 8 is touched by a touch pen 30 or the like, the second electroconductive film 12 is flexibly deformed together with the polarizing plate 8 by the touch pressure and locally comes into contact with the first electroconductive film 11 at a part corresponding to a point touched by the touch pen 30 or the like.

First strip-like electrodes 11a and 11b each of which is formed of a low-resistance metal film are provided on the upper surface of the first electroconductive film 11 at both end edges thereof along an entire length of each end edge in one of two perpendicular directions parallel to a film surface of the first electroconductive film 11, e.g., a direction of a vertical axis (which will be referred to as a Y-axis hereinafter) of the screen. Second strip-like electroconductive films 12a and 12b (see FIG. 2) each of which is formed of a low-resistance metal film are provided on the lower surface of the second electroconductive film 12 at both end edges thereof along a substantially entire length of each edge portion in the other one of the two directions, i.e., a direction of a lateral axis (which will be referred to as an X-axis hereinafter) of the screen.

Touched position coordinate detecting means shown in FIG. 2 is electrically connected with the first strip-like electrodes 11a and 11b and the second strip-like electrodes 12a and 12b.

The touched position coordinate detecting means is provided with a voltage application circuit which alternately applies a voltage having a fixed value between the second strip-like electrodes 12a and 12b and between the first strip-like electrodes 11a and 11b, a voltage measurement system which measures a voltage of one second strip-like electrode 12a and a voltage of one first strip-like electrode 11a when the second electroconductive film 12 locally comes into contact with the first electroconductive film 11, and coordinate detecting means 29 which detects a coordinate of the touch point based on the measured values.

The voltage application circuit has a constant voltage power supply or D.C. source 17, a first switch 20 which selectively and electrically connects one pole (a negative pole in the figure) of this constant voltage power supply 17 with one first strip-like electrode 11a or one second strip-like electrode 12a, and a second switch 23 which selectively and electrically connects the other pole (a positive pole in the figure) of the constant voltage power supply 17 with the other first strip-like electrode 11b or the other second strip-like electrode 12b. Although the constant voltage power supply 17 depicted in FIG. 2 is a direct-current power supply, this constant voltage power supply 17 may be a power supply which supplies an alternating voltage.

The voltage measurement system has voltage measuring means 28 having one terminal electrically connected with one pole (a negative pole in the figure) of the constant voltage power supply 17, and a third switch 27 which selectively and electrically connects one first strip-like electrode 11a or one second strip-like electrode 12a with the other terminal of this voltage measuring means 28.

In the voltage application circuit, non-illustrated controlling means switches the first and second switches 20 and 23 between a side or position where the second strip-like electrodes 12a and 12b are connected with the constant voltage power supply 17 (a state shown in FIG. 2) and a side or position where the first strip-like electrodes 11a and 11b are connected with the constant voltage power supply 17 in a preset cycle, e.g., a cycle of 0.1 seconds. As a result, a voltage having a constant value from the constant voltage power supply 17 is alternately applied between both ends of the second electroconductive film 12 in the X-axis direction (between the strip-like electrodes 12a and 12b) and between both ends of the first electroconductive film 11 in the Y-axis direction (between the strip-like electrodes 11a and 11b).

When the voltage is applied between both ends of the second electroconductive film 12 in the X-axis direction, the third switch 27 is switched to a side or position where the other terminal of the voltage measuring means 28 is connected with the strip-like electrode 11a (the state shown in FIG. 2), and the coordinate detecting means 29 thereby detects a coordinate of the touched point in the X-axis direction (which will be referred to as an X-coordinate hereinafter) based on the measured value of the voltage measuring means 28. When the voltage is applied between both ends of the first electroconductive film 11 in the Y-axis direction, the third switch 27 is switched to a side or position where the other end of the voltage measuring means 28 is connected with the strip-like electrode 12a, and the coordinate detecting means 29 detects a coordinate of the touch point in the Y-axis direction (which will be referred to as a Y-coordinate hereinafter) based on the measured value of the voltage measuring means 28.

That is, according to this liquid crystal display device, the observation-side polarizing plate 8 is arranged on the outer surface side of the observation-side substrate 1 with a gap therebetween, the rim portion thereof is supported by the observation-side substrate through the frame-like spacer 10. Further the first electroconductive film 11 is formed on the outer surface of the observation-side substrate 1, and the second electroconductive film 12 which is flexibly deformed together with the observation-side polarizing plate 8 to locally come into contact with the first electroconductive film 11 by a touch pressure locally applied to the outer surface of the observation-side polarizing plate 8 is provided on the inner surface of the observation-side polarizing plate 8 facing the observation-side substrate 1. Thus, there is formed the touch panel having the polarizing plate arranged on the outer surface side of the observation-side substrate being used as a touch surface.

According to this liquid crystal display device, at least one first electroconductive film is formed on at least one of the outer surface of the liquid crystal display apparatus and the polarizing plate, the touch panel which detects a position specified on the first electroconductive film based on a voltage previously applied to the first electroconductive film and a voltage measured at the specified position is formed, thereby reducing the thickness of the liquid crystal display apparatus including the touch panel.

### Second Embodiment

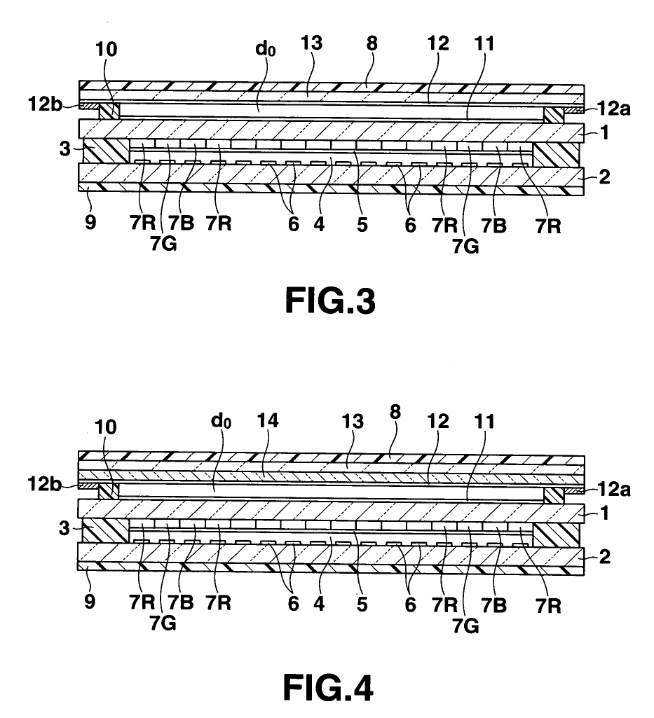

FIG. 3 is a cross-sectional view showing a liquid crystal display apparatus according to a second embodiment of the present invention. In this embodiment, like reference numerals denote members or parts which are substantially equal to those in the first embodiment, thereby eliminating their explanation.

According to a liquid crystal display device apparatus of this embodiment, an optical compensation film 13 which compensates display characteristics is arranged on a surface of an observation-side polarizing plate 8 close to an observation-side substrate 1 side, a second electroconductive film 12 is formed on a surface of the optical compensation film 13 close to the observation-side substrate 1 side, and other structures are the same as those in the first embodiment.

The optical compensation film 13 is formed of one of a contrast compensation film such as a phase plate which improves display contrast, and a discotic liquid crystal film which compensates the viewing angle dependence of a transmission factor of the liquid crystal display device to increase a viewing field of display or a viewing field compensation film such as a biaxial phase plate. Alternatively, the optical compensation film 13 is formed of a laminated film consisting of both these films.

In this embodiment, an ITO film is formed on one surface of the optical compensation film 13 to form the second electroconductive film 12, and an opposite surface of the electroconductive film formed surface of this optical compensation film 13 is attached to an inner surface of the observation-side polarizing plate 8.

This liquid crystal display device can improve a display quality such as display contrast and or a viewing field since the optical compensation film 13 which compensates display characteristics is laminated on the inner surface of the observation-side polarizing plate 8.

Further, according to this liquid crystal display device, since the second electroconductive film 12 is formed on the surface of the optical compensation film 13, the second electroconductive film 12 can be easily formed as compared with a case where the second electroconductive film 12 is directly formed on the surface of the observation-side polarizing plate 8. Therefore, manufacture of the liquid crystal display device can be facilitated.

Furthermore, according to this liquid crystal display device, the observation-side polarizing plate 8 can be reinforced by the optical compensation film 13, thus increasing the durability of the touch panel.

### Third Embodiment

FIG. 4 is a cross-sectional view showing a liquid crystal display device according to a third embodiment of the present invention. In this embodiment, like reference numerals denote constituent parts equal to those in the first and second embodiments, thereby eliminating their explanation.

According to a liquid crystal display device of this embodiment, an optical compensation film 13 which compensates display characteristics and an optically isotropic transparent film 14 are sequentially provided on a surface of an observation-side polarizing plate 8 on an observation-side substrate 1 side, a second electroconductive film 12 is formed on a surface of the transparent film 14, and other structures are the same as those in the first embodiment.

According to this liquid crystal display device, since the optical compensation film 13 and the transparent film 14 are laminated on the inner surface of the observation-side polarizing plate 8 and the second electroconductive film 12 is formed on the surface of the transparent film 14, display quality can be improved, and manufacture of the liquid crystal display device can be facilitated. Furthermore, the observation-side polarizing plate 8 is reinforced by the optical compensation film 13 and the transparent film 14, thus further improving the durability of the touch panel.

It is to be noted that the liquid crystal display device according to each of the first to third embodiments is a transmission type display device provided with the pair of polarizing plates 8 and 9 on the observation side and the opposite side, but the present invention can be likewise applied to a reflection type liquid crystal display device which includes one polarizing plate 8 on the observation side alone and has a reflecting film provided on an inner surface or an outer surface of the opposed substrate 2.

### Fourth Embodiment

Although the liquid crystal display apparatus according to each of the first to third embodiments is of a vertical electric field control type which generates a vertical electric field (an electric field in the thickness direction of a liquid crystal layer) between the electrodes provided on the inner surfaces of the pair of substrates to change an alignment state of liquid crystal molecules, the present invention is not restricted to the vertical electric field control type. The present invention can be also applied to a transverse electric field control type liquid crystal display device which has, e.g., comb-like first and second electrodes forming a plurality of pixels provided on an inner surface of a pair of substrates and generates a transverse electric field (an electric field in the direction along substrate surfaces) between these electrodes to change an alignment state of liquid crystal molecules.

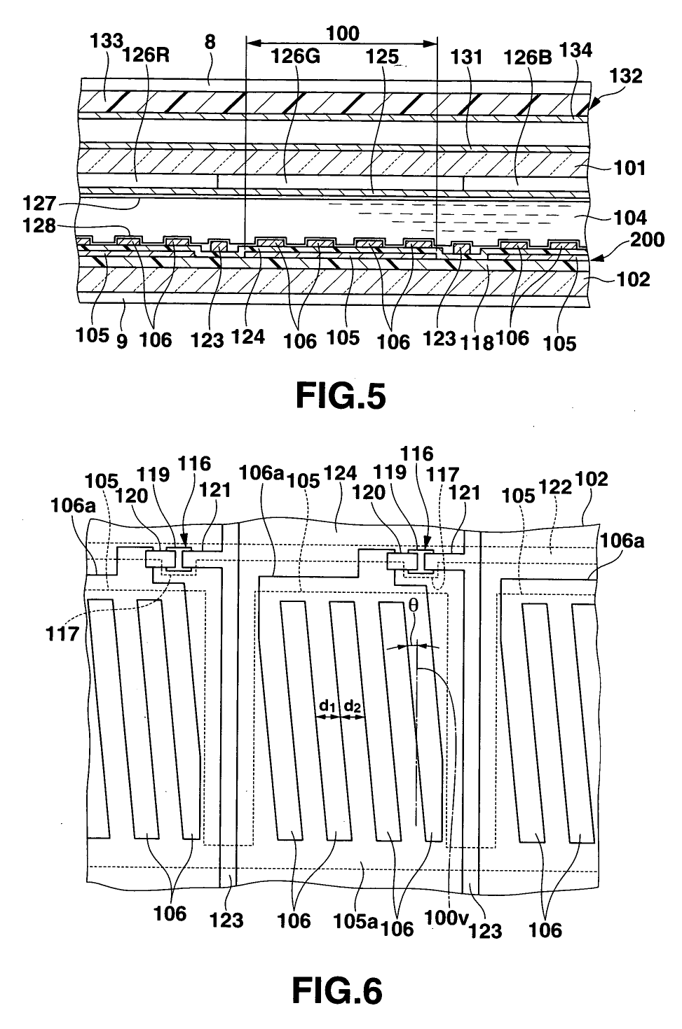

FIGS. 5 to 12A and 12B show a fourth embodiment of the present invention, wherein FIG. 5 is a cross-sectional view showing a part of a liquid crystal display device, and FIG. 6 is a plan view showing a part of one substrate in the liquid crystal display device. In this embodiment, like reference numerals denote members equal to those in the first embodiment, thereby eliminating their explanation.

In a liquid crystal display apparatus according to this embodiment, as shown in FIGS. 5 and 6, a liquid crystal display device is provided with a pair of transparent substrates 101 and 102 on an observation side (an upper side in FIG. 5) and an opposite side which face each other with a gap therebetween. A liquid crystal layer 104 of a nematic liquid crystal is sealed between the pair of substrates 101 and 102 and has a positive dielectric anisotropy. First and second transparent display electrodes 105 and 106 are insulated from each other, provided on one of opposed inner surfaces of the pair of substrates 101 and 102, e.g., an inner surface of the substrate 102 on the opposite side of the observation side, and generate a transverse electric field in a direction substantially parallel to the surface of the substrate 102 in the liquid crystal layer 104 by supplying a display drive voltage between these electrodes. A pair of polarizing plates 8 and 9 are arranged with the pair of substrates 101 and 102 therebetween.

According to this liquid crystal display device, when a display drive voltage corresponding to image data is supplied between the first and second display electrodes 105 and 106 which are insulated from each other and provided on the inner surface of one substrate (which will be referred to as an opposite-side substrate hereinafter) 102, a transverse electric field in a direction substantially parallel to the surface of the substrate 102 is generated between the first and second display electrodes 105 and 106, and an alignment direction (a direction of molecular long axes) of liquid crystal molecules in the liquid crystal layer 104 sealed between the substrate 101 and 102 is controlled by the transverse electric field within a plane substantially parallel to the surface of the substrate 102, thereby display an image. In this liquid crystal display device, each pixel 100 which is a minimum unit for displaying an image is defined by a region in which an alignment direction of the liquid crystal molecules is controlled by the transverse electric field generated between the first and second display electrodes 105 and 106.

The pixels 100 are arranged in a matrix form in a row direction (a lateral direction of a screen in the liquid crystal display device) and a column direction (a vertical direction of the screen). Of the first and second display electrodes 105 and 106 arranged on the inner surface side of the opposite-side substrate 102, the first display electrode 105 is formed in accordance with at least the entire region of each pixel 100, and the second display electrode 106 is formed into a shape having an area smaller than each pixel 100 on an interlayer insulating film 124 provided to cover the first display electrode 105 and faces the first display electrode 105 at edge portions thereof.

This liquid crystal display device is an active matrix liquid crystal display device which selects and drives the plurality of pixels 100 arranged in the matrix form by using an active element formed of a thin-film transistor (TFT) 116. The TFT 116 has a gate electrode 117 formed on the opposite-side substrate 102, a gate insulating film 118 formed on a substantially entire surface of the opposite-side substrate 102 to cover the gate electrode 117, an i-type semiconductor film 119 which is formed on the gate insulating film 118 to face the gate electrode 117, and a source electrode 120 and a drain electrode 121 provided on both side portions of the i-type semiconductor film 119 through an n-type semiconductor film (not shown).

Furthermore, on the inner surface side of the opposite-side substrate 102 are provided a plurality of gate wiring lines 122 which supply gate signals to the TFTs 116 in the respective rows and a plurality of data wiring lines 123 which supply data signals to the TFTs 116 in the respective columns. Each gate wiring line 122 is connected with the gate display electrode 117 of the TFT 116 and each data wiring line 123 is connected with the drain electrode 121 of the TFT 116.

The first display electrode 105 is constituted of an ITO film 105a formed into a shape corresponding to an entire region of the pixel 100 in accordance with each pixel row on the gate insulating film 118, and these ITO films 105a are equally connected with each other at end portions thereof.

In this embodiment, a width of a part between regions of the ITO films 105a corresponding to the respective pixels 100 is small. However, this ITO film 105a may be formed with a width corresponding to an entire region of the pixel 100 over the entire length thereof, or it may be formed as one electrode corresponding to an entire display region of the liquid crystal display device in which the plurality of pixels 100 are arranged.

Moreover, the second display electrode 106 is constituted of a comb-like ITO film 106a patterned into a comb-like shape having a plurality of comb tooth portions, e.g., four comb tooth portions formed at equal intervals, and it is connected with the source electrode 120 of the TFT 116 at one end of a base portion of this comb-like ITO film 106 connecting the respective comb tooth portions.

The interlayer insulating film 124 is provided on substantially the entire surface of the opposite-side substrate 102 to cover the first display electrodes 105, the TFTs 116 and the data wiring lines 123, and the comb-like ITO film 106a is connected with the source electrode 120 of the TFT 116 in a contact hole (not shown) provided in the interlayer insulating film 124.

Each tooth portion of the second display electrode 106 is formed into an elongated shape which is in parallel to a direction inclined at an angle θ of 5° to 15° to either a right side or a left side with respect to the vertical direction of the screen in the liquid crystal display device, i.e., a vertical axis 100v of the screen. A ratio d2/d1 of a width d1 of each of these comb tooth portions and a gap d2 between the adjacent comb tooth portions is set to ⅓ to 3/1 or preferably 1/1.

Moreover, this liquid crystal display device is provided with a transparent viewing angle control electrode 125 provided on the inner surface side of the other one of the pair of substrates 101 and 102, i.e., the observation-side substrate 101 in accordance with at least the entire region of the pixels 100.

When a viewing angle control voltage independent from the display drive voltage supplied between the first and second display electrodes 105 and 106 is supplied to one of the first and second display electrodes 105 and 106 or between these electrodes, this viewing angle control electrode 125 generates a vertical electric field in a direction substantially parallel to a thickness direction of the liquid crystal layer 104 between the first display electrode 105 and/or the second display electrodes 106, and it is constituted of one film-like ITO film facing an entire arrangement region of the plurality of pixels 100.

This liquid crystal display device is provided with colors filters 126R, 126G and 126B of three colors, i.e., red, green and blue corresponding to each of the plurality of pixels 100, the color filters 126R, 126G and 126B are formed on the observation-side substrate 101, and the viewing angle control electrode 125 is formed on these color filters.

Additionally, homogeneous alignment films 127 and 128 are provided on the inner surface sides of the observation-side substrate 101 and the opposite-side substrate 102 to cover the first and second display electrodes 105 and 106 and the viewing angle control electrode 125. These alignment films 127 and 128 are respectively rubbed in opposite directions to be aligned along a direction obliquely crossing at a predetermined angle a direction of a transverse electric field generated between the first and second display electrodes 105 and 106.

The alignment films 127 and 128 are respectively aligned in opposite directions along a direction obliquely crossing at a predetermined angle (5° to 10°) a length direction of an edge part of the second display electrode 106, i.e., an edge part of each tooth portion of the comb-like ITO film 106.

Both substrates 101 and 102 are jointed with each other through a frame-like sealing material (not shown) surrounding the arrangement region of the plurality of pixels 100 or the display region, and the liquid crystal layer 104 is sealed in a region surrounded by the sealing material between the observation-side substrate 101 and the opposite-side substrate 102.

Liquid crystal molecules of the liquid crystal layer 104 are aligned in substantially parallel to the surfaces of the substrates 101 and 102 with molecular long axes being aligned in the aligning treatment directions of the alignment films 127 and 128.

Further, in a state where the liquid crystal molecules of this liquid crystal display device are aligned in substantially parallel to the surfaces of the substrates 101 and 102 with the molecular long axes being aligned in the aligning treatment directions of the alignment films 127 and 128, a value of Δnd (a product of a refractive anisotropy Δn of the liquid crystal and a liquid crystal layer thickness d) is set to approximately 275 nm which is a value of half of an intermediate wavelength of a visible light band.

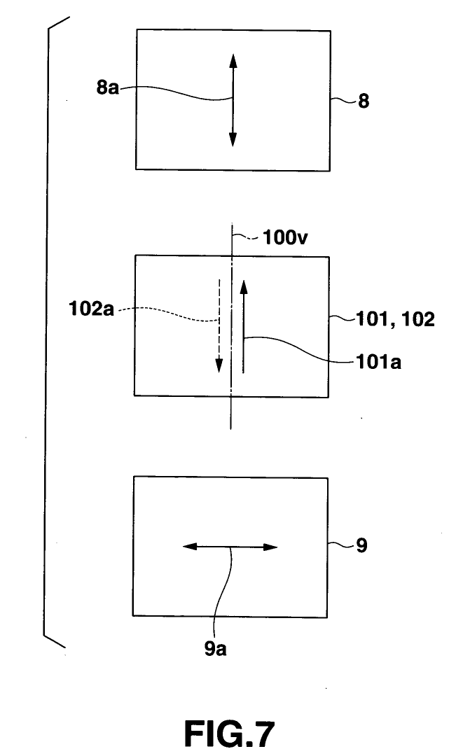

FIG. 7 shows aligning treatment directions (rubbing directions) 101a and 102a of the alignment films 127 and 128 of the observation-side substrate 101 and the opposite-side substrate 102 and directions of transmission axes 8a and 9a of the pair of polarizing plates 8 and 9 in the liquid crystal display device.

As shown in FIG. 7, the alignment films 127 and 128 of the substrates 101 and 102 are subjected to the aligning treatment in opposite directions along a direction inclined at the angle θ of 50° to 10° with respect to each comb tooth portion formed into the elongated shape along a direction inclined at the angle θ toward a direction substantially parallel to the vertical direction (a vertical axis 100v of the screen) of the screen in the liquid crystal display device, i.e., toward one of right and left directions with respect to the vertical axis 100v of the screen. Of the pair of polarizing plates 8 and 9, the observation-side polarizing plate 8 is arranged in such a manner that its transmission axis 8a becomes substantially parallel to the aligning treatment directions 101a and 102a, and the opposite-side polarizing plate 9 is arranged in such a manner that its transmission axis 9a becomes substantially perpendicular or parallel to the transmission axis 8a of the observation-side polarizing plate 8.

Furthermore, in this embodiment, the transmission axis 8a of the observation-side polarizing plate 8 is set to be perpendicular to the transmission axis 9a of the opposite-side polarizing plate 9 to constitute a liquid crystal display device in a normally black mode.

Moreover, this liquid crystal display device is further provided with a transparent touch panel 132 on the outer surface side of the observation-side substrate 101 in accordance with the entire display region. The touch panel 132 includes one film-like transparent antistatic first electroconductive film 131 (which will be referred to as an antistatic electroconductive film hereinafter) made of ITO or the like having a predetermined resistance value and a transparent second electroconductive film (which will be referred to as a touch-side electroconductive film hereinafter) 134 which is oppositely arranged on the outer surface side of the observation-side substrate 101 with a gap therebetween, faces the first electroconductive film 131 and consists of ITO or the like having a predetermined resistance value.

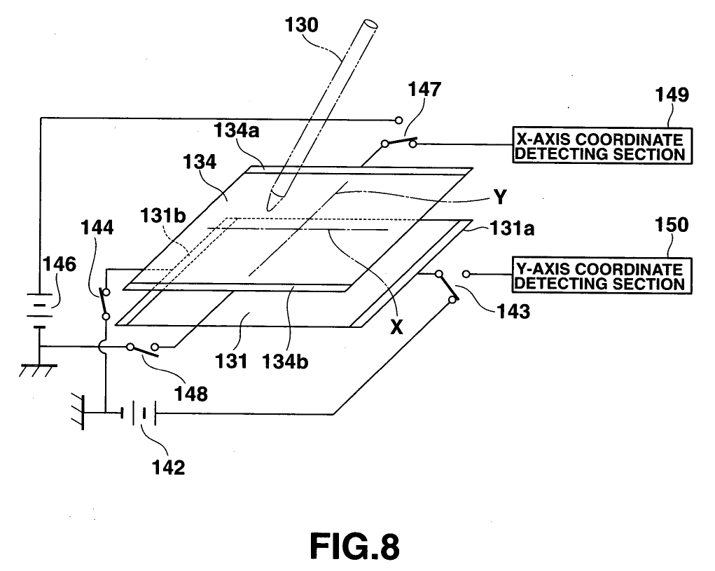

The observation-side polarizing plate 8 is attached on an outer surface of the touch panel 132 (an observation-side surface), and a transparent surface film (not shown) which protects the observation-side polarizing plate 8 against touch input using a touch pen 130 (see FIG. 8) or the like is attached on the outer surface of the observation-side polarizing plate 8. A transparent film substrate 133 having an outer shape substantially equal to that of the observation-side substrate 101 and the touch panel 132 are constituted of the transparent second electroconductive film 134 which is provided on one surface of this film substrate 133 and is made of ITO or the like and the transparent film substrate 133 which has this second electroconductive film 134 provided on the inner surface thereof and has the outer shape substantially equal to that of the observation-side substrate 101. This second electroconductive film (which will be referred to as a touch electroconductive film hereinafter) 134 is formed into a single film-like shape having an outer shape substantially equal to the first electroconductive film 131.

Moreover, the touch film 132 is arranged on the outer surface side of the observation-side substrate 101 in such a manner that the touch-side electroconductive film 134 faces the antistatic electroconductive film 131 with an appropriate gap therebetween through a frame-like spacer (not shown) surrounding the screen region. The touch film 132 and the antistatic electroconductive film 131 form a touch input portion which is flexibly deformed by local touching from the observation-side to locally bring the touch-side electroconductive film 134 into contact with the antistatic electroconductive film 131.

As described above, according to this liquid crystal display apparatus, the antistatic electroconductive film 131 provided on the outer surface side of the observation-side substrate 101 and the touch panel 132 constituted of the film substrate 133 arranged with a gap and the touch-side electroconductive film 134 provided on one surface of the film substrate 133 form the touch input portion. Therefore, the single film substrate 133 alone is provided, and hence the configuration can be simplified to reduce the thickness.

FIG. 8 shows touched position coordinate detecting means connected with the touch input portion in the liquid crystal display device.

Assuming that the lateral direction of the screen of the liquid crystal display device 200 is an X-axis and a vertical direction of the screen is a Y-axis, this touched position coordinate detecting means detects a position on the touch panel 132 touched by the touch pen 130 or the like, i.e., an X-axis coordinate and a Y-axis coordinate of the contact position of antistatic electroconductive film 131 and the touch-side electroconductive film 134. This touched position coordinate detecting means is constituted of: an X-axis power supply system which supplies an X-axial voltage of an X-axis power supply or D.C. source 142 between both end edges of the antistatic electrocondutive film 131 in the X-axis direction in a fixed cycle; a Y-axis power supply system which supplies a Y-axial voltage of a Y-axis power supply 146 between both end edges of the touch-side electroconductive film 134 in the Y-axis direction in a cycle having a reversed phase with respect to the X-axial voltage supply cycle; an X-axis coordinate detecting portion 149 which detects an X-axis coordinate of the touched position based on a voltage value fetched from one end edge of the touch-side electroconductive film 134 in the Y-axis direction when the X-axial voltage is supplied to the antistatic electroconductive film 131; and a Y-axis coordinate detecting portion 150 which detects a Y-axis coordinate of the touched position based on a voltage value at one end edge of the antistatic electroconductive film 131 in the X-axis direction when the Y-axial voltage is supplied to the touch-side electroconductive film 134.

The X-axis power supply system includes a first switch 143 which switches connection between one pole of the X-axis power supply 142 and one end edge of the antistatic electroconductive film 131 in the X-axis direction and connection between one pole of the X-axis power supply 142 and the Y-axis coordinate detecting portion 150, and a second switch 144 which turns on/off connection between the other pole of the X-axis power supply 142 and the other end edge of the antistatic electroconductive film 131 in the X-axis direction in synchronization with the first switch 143.

Moreover, the Y-axis power supply system includes a third switch 147 which alternately switches connection between one pole of the Y-axis power supply or D.C. source 146 and one end edge of the touch-side electroconductive film 134 in the Y-axis direction and connection between one pole of the Y-axis power supply 146 and the X-axis coordinate detecting portion 149 at a timing opposite to that of the first switch 143, and a fourth switch 148 which turns on/off connection between the other pole of the Y-axis power supply 146 and the other end edge of the touch-side electroconductive film 134 in the Y-axis direction in synchronization with the third switch 147.

Linear electrodes 131a, 131b, 134a and 134b which equally apply the X-axial voltage and the Y-axial voltage, respectivelly and are formed of a low-resistance metal film superimposed on each end edge over the entire length are provided at both end edges of the antistatic electroconductive film 131 in the X-axis direction and both end edges of the touch-side electroconductive film 134 in the Y-axis direction, respectively.

The touched position coordinate detecting means alternately supplies the X-axial voltage and the Y-axial voltage between both end edges of the antistatic electroconductive film 131 in the X-axis direction and between both end edges of the touch-side electroconductive film 134 in the Y-axis direction. When the X-axial voltage is supplied to the antistatic electroconductive film 131, a voltage in the X-axis direction corresponding to a position of a contact part between the antistatic electroconductive film 131 and the touch-side electroconductive film 134 is acquired from the end edges of the touch-side electroconductive film 134 in the Y-axis direction through the contact part, and an X-axis coordinate of the touched position is detected based on the voltage value by the X-axis coordinate detecting portion 149. When the Y-axial voltage is supplied to the touch-side electroconductive film 134, a voltage in the Y-axis direction corresponding to the position of the contact part between the antistatic electroconductive film 131 and the touch-side electroconductive film 134 is acquired from the end edges of the antistatic electroconductive film 131 in the X-axis direction through the contact part, and a Y-axis coordinate of the touched position is detected based on this voltage value by the Y-axis coordinate detecting portion 150.

In the touched position coordinate detecting means shown in FIG. 8, the X-axis power supply system and the Y-axis power supply system are provided with the X and Y-axis power supplies 142 and 146, respectively. However, these power supply systems may be configured to share one power supply like the first embodiment.

Since this liquid crystal display device controls an alignment direction of the liquid crystal molecules based on the transverse electric field to display an image, even if the observation-side substrate 101 is inwardly deformed by touching the touch panel 132 and display in this part is distorted by a change in the liquid crystal layer thickness, an electric field is not greatly distorted in the part with the changed liquid crystal layer thickness. Therefore, after the observation-side substrate 101 is restored by canceling touching the touch panel 132, the distortion of display can be rapidly eliminated without producing local storage of electric charges. Accordingly, it is possible to perform display without leaving the influence of touch input.

As described above, according to the liquid crystal display device of this embodiment, when the display drive voltage corresponding to image data is applied between the first and second display electrodes 105 and 106 insulated from each other and provided on the inner surface of one of the pair of substrates 101 and 102 on the observation side and the opposite side, e.g., the opposite-side substrate 102, a transverse electric field in a direction substantially parallel to the surface of the substrate 102 is generated between the first and second display electrodes 105 and 106. Thus, an alignment direction of the liquid crystal molecules (a direction of molecular long axes) in the liquid crystal layer 104 sealed between the pair of substrates 101 and 102 is controlled within a plane substantially parallel to the surface of the substrate 102 by using the transverse electric field, thereby displaying an image. In this liquid crystal display device, the antistatic electroconductive film 131 is provided in the entire region of the liquid crystal layer 104 on the outer surface of the observation-side substrate 101, and this antistatic electroconductive film 131 is used as one electrode of the touch panel. Therefore, electrostatic electricity applied from the observation side does not affect control over the alignment direction of the liquid crystal molecules by the transverse electric field, and the thickness can be reduced.

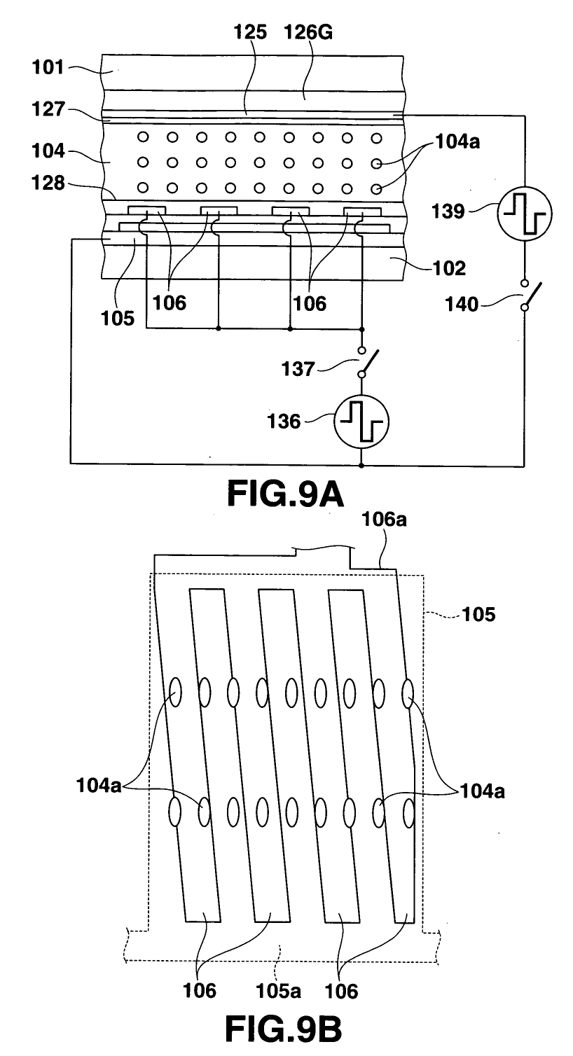

Further, this liquid crystal display device is driven as follows. FIGS. 9A, 9B to 12A and 12B show a concept of a method of driving this liquid crystal display device. That is, this liquid crystal display device is driven for display by image display driving means having a signal source 136 which generates a display drive voltage corresponding to image data, and a write switch 137 which supplies the display drive voltage from the signal source 136 between the first and second display electrodes 105 and 106 of each pixel 100 in the liquid crystal display device.

The write switch 137 supplies the display drive voltage corresponding to image data between the first and second display electrodes 105 and 106 of each pixel 100 in the liquid crystal display device, and generates a transverse electric field corresponding to the display drive voltage between the first and second display electrodes 105 and 106.

Furthermore, this liquid crystal display apparatus is provided with viewing angle control driving means having a signal source 139 which generates a viewing angle control voltage having a predetermined value and a viewing angle control switch 140 which supplies the viewing angle control voltage from the signal source 139 between one or both of the first and second display electrodes 105 and 106 of each pixel 100 in the liquid crystal display device, e.g., the first display electrode 105 and the viewing angle control electrode 125, thereby controlling a viewing angle for display to a narrow viewing angle from a wide viewing angle.

When the viewing angle control switch 140 is turned on, this viewing angle control driving means supplies between the first display electrode 105 of each pixel 100 in the liquid crystal display device and the viewing angle control electrode 125 a viewing angle control voltage which is independent from the display drive voltage supplied between the first and second display electrodes 105 and 106. Moreover, a vertical electric field in a direction substantially parallel to the thickness direction of the liquid crystal layer 104 is generated between the first display electrode 105 and the viewing angle control electrode 125. The viewing angle control voltage is set to a value which generates a vertical electric field which aligns the liquid crystal molecules to be obliquely raised at a preset angle in a range of, e.g., 45° to 70° with respect to the surfaces of the substrates 101 and 102 between the first display electrode 105 and the viewing angle control electrode 125.

The viewing angle control switch 140 is a changeover switch which is turned off in accordance with selection of a wide viewing angle by a viewing angle selection key provided in an electronic device such as a mobile phone including the liquid crystal display apparatus, and turned on in accordance with selection of a narrow viewing angle by the viewing angle selection key.

As described above, according to the liquid crystal display device, the image display driving means supplies a display drive voltage corresponding to image data between the first and second display electrodes 105 and 106 on the inner surface of the opposite-side substrate 102, and a transverse electric field corresponding to the display drive voltage is generated between the first and second display electrodes 105 and 106, thereby displaying an image. The viewing angle control driving means supplies a viewing angle control voltage independent from the display drive voltage between the first display electrode 105 on the inner surface of the opposite-side substrate 102 and the viewing angle control electrode 125 provided on the inner surface of the observation-side substrate 101 in accordance with at least the entire region of the pixel 100, and a vertical electric field corresponding to the viewing angle control voltage is generated between the first display electrode 104 and the viewing angle control electrode 125, thereby controlling a viewing angle.

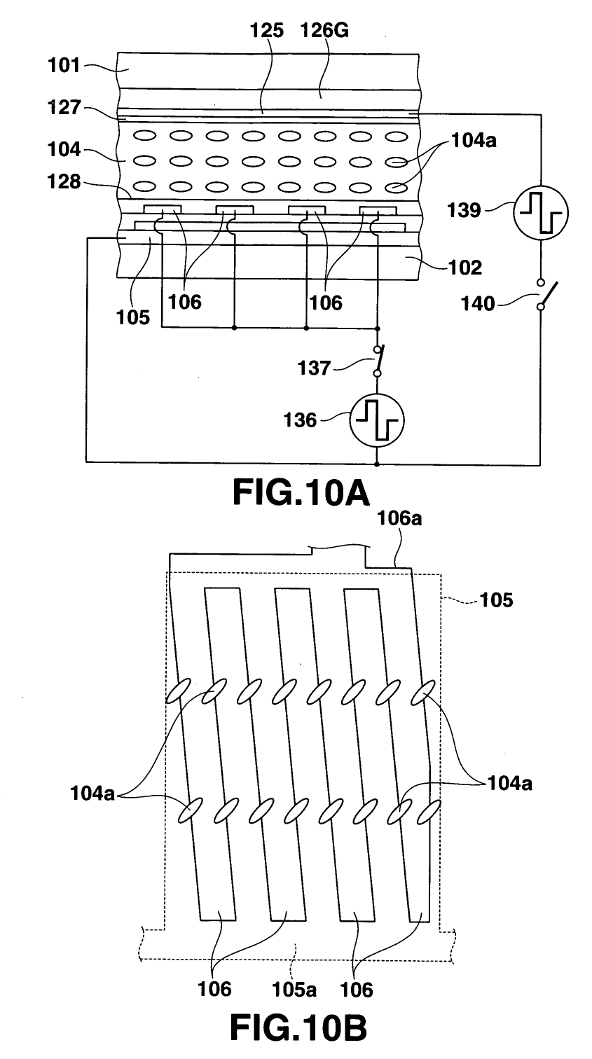

FIGS. 9A and 9B and FIGS. 10A and 10B schematically show a change in alignment of the liquid crystal molecules in a single pixel 100 of the liquid crystal display device in a state where a vertical electric field is not generated. FIGS. 9A and 9B show an alignment direction when the transverse electric field is not generated either, and the liquid crystal molecules 104a are aligned in substantially parallel to the surfaces of the substrates 101 and 102 in such a manner that molecular long axes are aligned in the aligning treatment directions 101a and 102a of the alignment films 127 and 128 of the pair of substrates 101 and 102. When the transverse electric field is generated between the first and second display electrodes 105 and 106, a transverse electric field in a direction substantially parallel to the surface of the opposite-side substrate 102 is generated between the first display electrode 105 and the edge portions of the second display electrodes 106 as shown in FIGS. 10A and 10B, and this transverse electric field allows the liquid crystal molecules 104a to be aligned with the molecular long axes being aligned in a direction of the transverse electric field. The liquid crystal molecules 104a in other regions in the pixel 100 (regions corresponding to the center of each comb tooth portion and the center between the adjacent comb tooth portions of the second display electrode 106 formed of the comb-like ITO film 106a) are likewise aligned by the influence of a behavior of the liquid crystal molecules.

Furthermore, in a state where the vertical electric field is not generated, the liquid crystal molecules 104 change its alignment direction (a direction of the molecular long axes) within a plane substantially parallel to the surfaces of the substrates 101 and 102 by the transverse electric field generated between the first and second display electrodes 105 and 106. Therefore, the viewing angle dependence of Δnd of the liquid crystal display device is small, thereby obtaining a wide viewing angle which is characteristic of the transverse electric field control type liquid crystal display device.

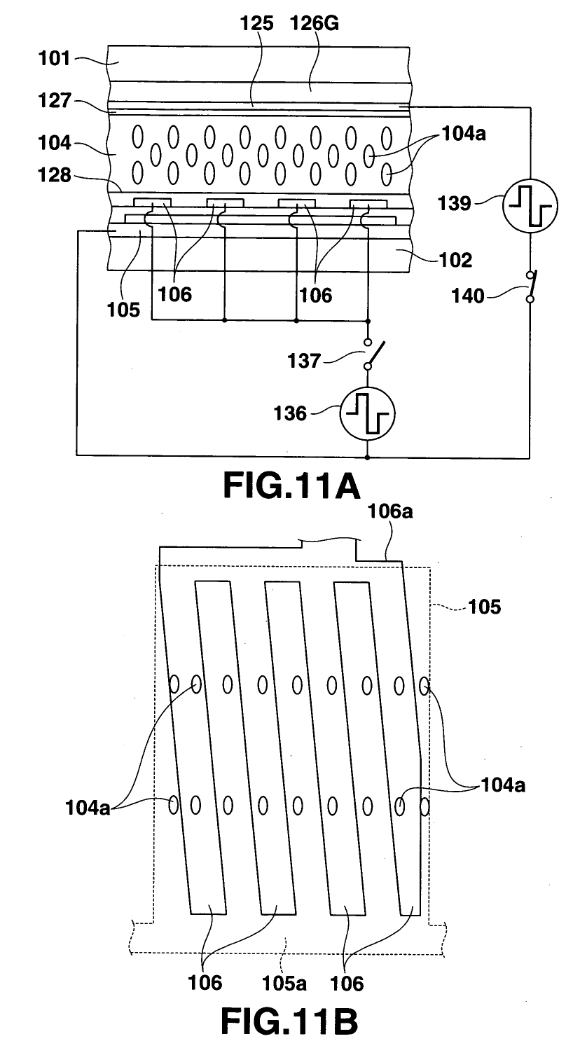

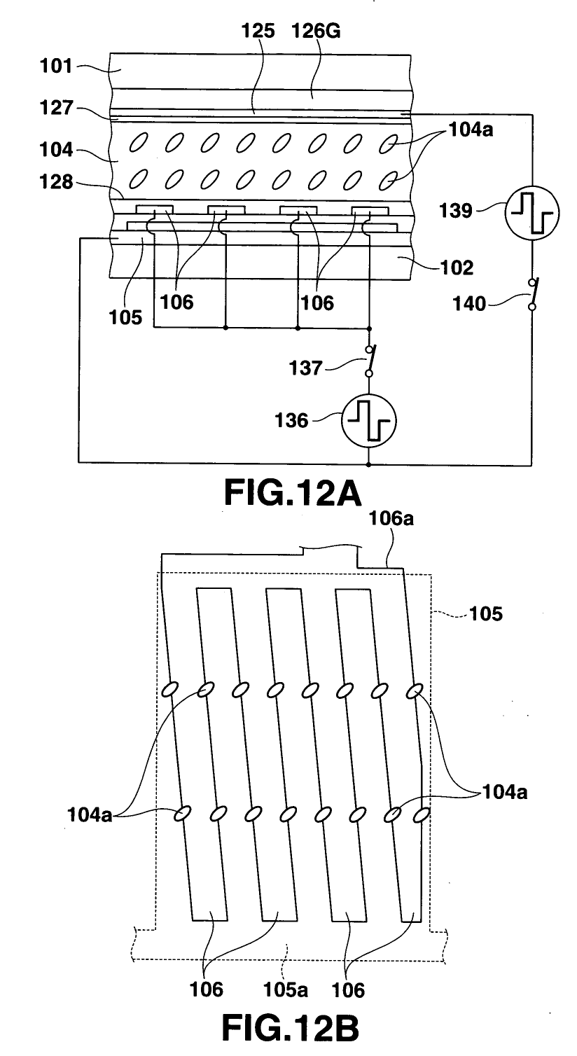

FIGS. 11A and 11B and FIGS. 12A and 12B schematically show alignment directions of the liquid crystal molecules of a single pixel 100 in the liquid crystal display device in a state where a vertical electric field is generated. FIGS. 11A and 11B show an alignment direction of the liquid crystal molecules 104a when a transverse electric field is not generated between the first and second display electrodes 105 and 106, and FIGS. 12A and 12B show an alignment direction of the liquid crystal molecules 104a when the transverse electric field is generated between the first and second display electrodes 105 and 106.

When the viewing angle control voltage is applied between the first display electrode 105 and the viewing angle control electrode 125 in the pixel 100, a vertical electric field in a direction substantially parallel to the thickness direction of the liquid crystal layer 104 is generated between the display electrode 105 having a shape corresponding to the entire region of the pixel 100 and the viewing angle control electrode 125, and the liquid crystal molecules 104a are aligned to be obliquely raised with respect to the surfaces of the substrates 101 and 102 by this vertical electric field.

Moreover, when the vertical electric field is generated, the liquid crystal molecules 104a change its alignment direction by a transverse electric field generated between the first and second display electrodes 105 and 106 in a state where the liquid crystal molecules 104a are aligned to be obliquely raised with respect to the surfaces of the substrates 101 and 102.

That is, in the state where the vertical electric field is generated, the liquid crystal molecules 104a are aligned in the raised state in such a manner that the molecular long axes are aligned in the aligning treatment directions 101a and 102a of the alignment films 127 and 128 of the pair of substrate 101 and 102 as shown in FIG. 11B when the transverse electric field is not generated between the first and second display electrodes 105 and 106. The liquid crystal molecules 104a are aligned in such a manner that the molecular long axes are aligned in a direction of the transverse electric field as shown in FIG. 12B when the transverse electric field is generated between the first and second display electrodes 105 and 106.

Additionally, in a state where the transverse electric field is generated, the viewing angle dependence of Δnd of the liquid crystal display device is increased due to rising alignment of the liquid crystal molecules 104a in an oblique direction. Therefore, display as seen from a front direction of the liquid crystal display device (a direction in the vicinity of a normal line of the liquid crystal display device) is display with excellent contrast which is almost the same as display in the state where the vertical electric field is not generated. However, as seen from a direction obliquely inclined with respect to the front direction, a phase difference which is different from seeing in the front direction is produced due to the viewing angle dependence of And, and display can be hardly visually recognized.

Therefore, at this time, a viewing angle with which display can be visually recognized with sufficient contrast is a narrow range in the front direction, and it is possible to perform highly secure display with a narrow viewing angle which cannot be overseer by other persons in an oblique direction.

According to this liquid crystal display device, the first and second display electrodes 105 and 106 which generate a transverse electric field in a direction substantially parallel to the surface of the substrate 102 between themselves by supplying a display drive voltage therebetween are insulated from each other and provided on the inner surface of one substrate (the opposite-side substrate) 102, and the viewing angle control electrode 125 is provided on the inner surface of the other substrate (the observation-side substrate) 101 in accordance with at least the entire region of the pixel 100 formed of a region in which an alignment direction of the liquid crystal molecules 104a is controlled by a transverse electric field generated between the first and second display electrodes 105 and 106. A viewing angle control voltage independent from a display drive voltage supplied between the first and second display electrodes 105 and 106 is supplied between one of the first and second display electrodes 105 and 106, e.g., the first display electrode 105 and the viewing angle control electrode 125, and the viewing angle control electrode generates a vertical electric field in a direction substantially parallel to the thickness direction of the liquid crystal layer 104. Therefore, it is possible to perform wide viewing angle display which is characteristic of the liquid crystal display device of a transverse electric field control type and narrow viewing angle display in which the liquid crystal molecules 104a are obliquely raised and aligned with respect to the surfaces of the substrates 101 and 102 by the vertical electric field to narrow a viewing angle. Further, the viewing angle can be stably controlled in a sufficiently wide angle range.

It is to be noted that a viewing angle control voltage is supplied between the first display electrode 105 and the viewing angle control electrode 125 in this embodiment, but the viewing angle control voltage may be supplied between the second display electrode 106 and the viewing angle control electrode 125 to generate a vertical electric field between this second display electrode 106 and the viewing angle control electrode 125. In this case, the same wide angle viewing angle display and narrow viewing angle display can be performed.

Furthermore, according to this liquid crystal display device, the alignment films 127 and 128 formed on the inner surfaces of the pair of substrates 101 and 102 are respectively subjected to the aligning treatment in the opposite directions along a direction which is substantially parallel to the vertical direction of the screen (the vertical axis 100v of the screen). Of the pair of polarizing plates 8 and 9, the observation-side polarizing plate 8 is arranged in such a manner that its transmission axis 8a becomes substantially parallel to the aligning treatment directions 101a and 102a, and the opposite-side polarizing plate 9 is arranged in such a manner that its transmission axis 9a becomes substantially perpendicular to the transmission axis 8a of the observation-side polarizing plate 8. Therefore, it is possible to acquire a wide viewing angle in an angle range inclined at substantially the same angles in right and left directions with respect to the normal line of the liquid crystal display device, and a narrow viewing angle obtained by narrowing the angle range at substantially the same angles from right and left directions.

Although the liquid crystal display device according to the foregoing embodiment is in the normally black mode, but it is possible to adopt a normally white mode in which the observation-side and opposite-side polarizing plates 8 and 9 are arranged in such a manner that their transmission axes 8a and 9a become substantially parallel to each other.

### Fifth Embodiment

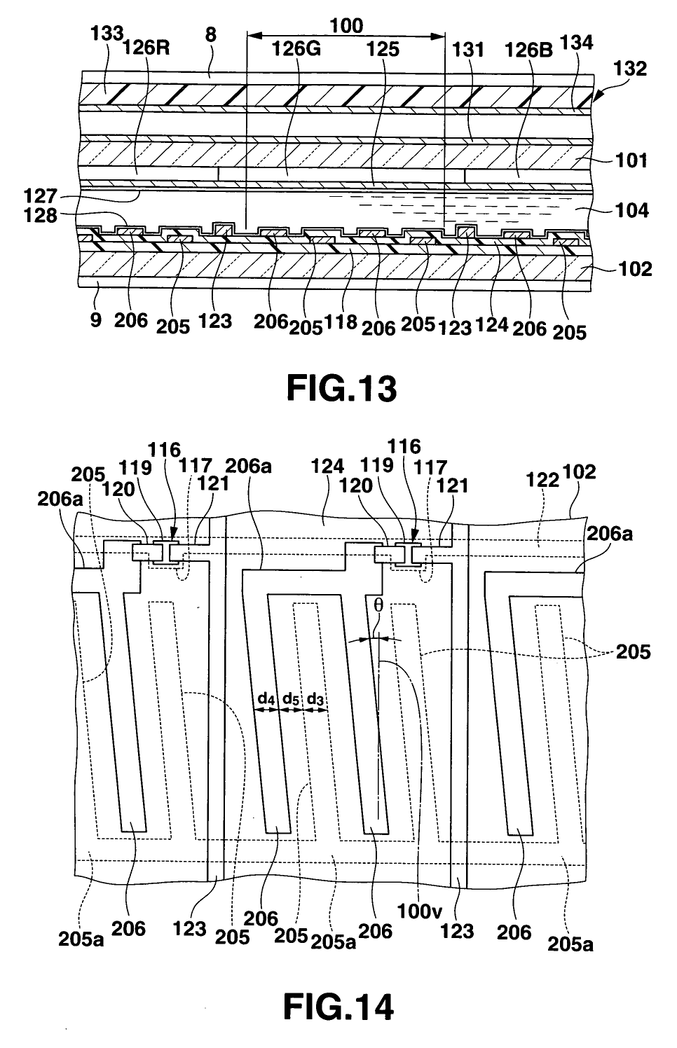

FIGS. 13 and 14 is a cross-sectional view showing a part of a liquid crystal display device according to a fifth embodiment of the present invention, and a plan view showing a part of one substrate in the liquid crystal display device. In this embodiment, like reference numerals denote corresponding parts in the fourth embodiment, thereby eliminating their explanation.

According to the liquid crystal display device of this embodiment, both first and second display electrodes 205 and 206 on an inner surface side of an opposite-side substrate 102 are formed of comb-like ITO films 205a and 206a patterned into a comb-like shape having a plurality of comb tooth portions, these display electrodes 205 and 206 are provided in a direction parallel to the surface of the substrate 102 with a gap therebetween, and other structures are the same as those in the fourth embodiment.

In this embodiment, the first comb-like ITO film 205a forming the first display electrode 205 is formed into a shape obtained by integrally connecting the comb-like ITO films 205a corresponding to a plurality of pixels 100 in a pixel row with each other in accordance with each of such rows. The comb-like ITO films 205a in each row are equally connected at end portions thereof. The second comb-like ITO films 206a forming the second display electrode 206 are provided in accordance with each pixel 100, and respectively connected with a plurality of TFTs 116 formed on the inner surface of the opposite-side substrate 102.

Further, each tooth portion of the first comb-like ITO film 205a and the second comb-like ITO film 206a is formed into an elongated shape along a direction inclined at an angle θ of 5° to 15° in one of right and left directions with respect to a vertical direction of a screen in the liquid crystal display device, i.e., a vertical axis 100v of the screen. Each of ratios d5/d3 and d5/d4 of widths d3 and d4 of these tooth portions and a gap d5 between the tooth portion of the first comb-like ITO film 205a and the tooth portion of the second comb-like ITO film 206a is set to ⅓ to 3/1, or preferably 1/1.

In the liquid crystal display device according to this embodiment, likewise, an antistatic electroconductive film 131 which also serves as one electrode of a touch panel is provided on an outer surface of an observation-side substrate 101 in accordance with an entire region of a liquid crystal layer 104. Therefore, electrostatic electricity applied from the observation side does not affect control over an alignment direction of liquid crystal molecules by a transverse electric field. Accordingly, it is possible to perform stable display which is not affected by the static electricity.

Furthermore, according to this liquid crystal display device, since the touch panel having the antistatic electroconductive film 131 as one electrode is provided on the outer surface side of the observation-side substrate 101, the configuration can be simplified to reduce thickness, and a touch input function can be provided.

Moreover, according to this liquid crystal display device, since a viewing angle control electrode 125 is provided on the inner surface side of the observation-side substrate 101 like the liquid crystal display device according to the first embodiment, both wide viewing angle display and narrow viewing angle display can be carried out, and a viewing angle in such display can be stably controlled in a wide angle range.

In the liquid crystal display device according to the fourth or fifth embodiment, the first and second display electrodes 105 and 106 or 205 and 206 which generate a transverse electric field are provided on the inner surface side of the substrate 102 on the opposite side of the observation side, and the viewing angle control electrode 125 is provided on the inner surface side of the observation-side substrate 101. However, conversely, the first and second display electrodes may be provided on the inner surface of the observation-side substrate 101, and the viewing angle control electrode may be provided on the inner surface of the opposite-side substrate 102.

Moreover, the touch panel according to the present invention can be also applied to a liquid crystal display device which does not perform viewing angle control.

### Sixth Embodiment

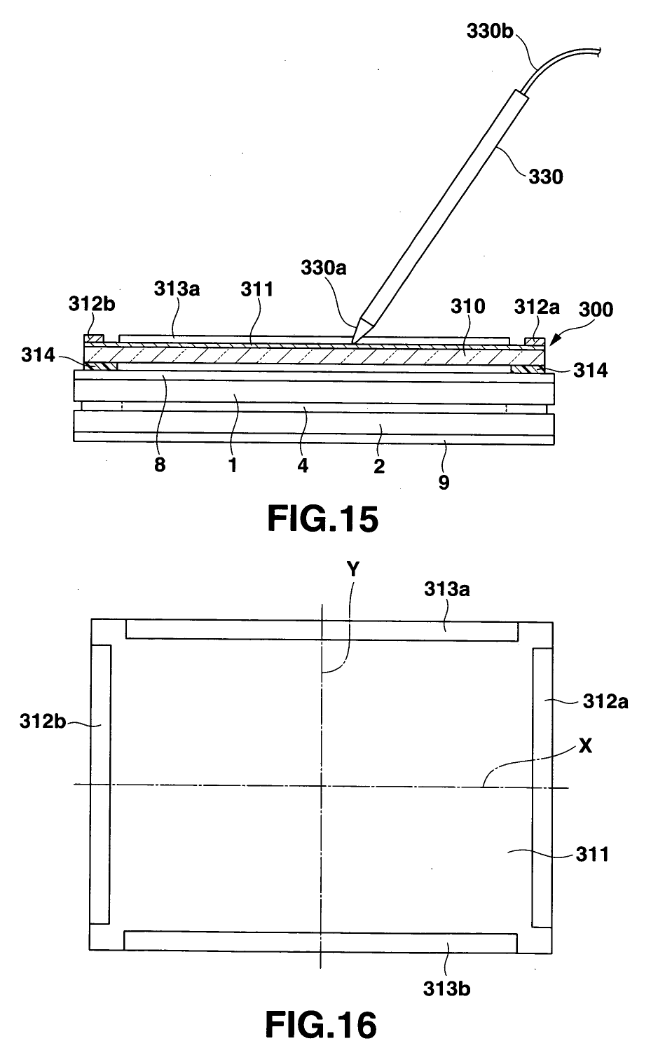

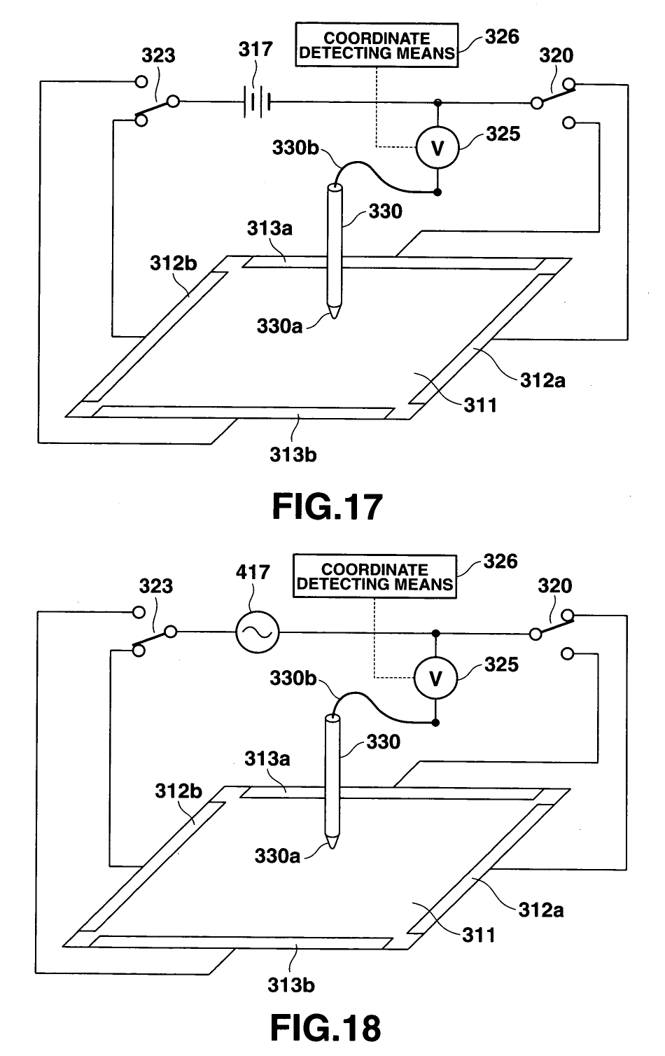

FIGS. 15 to 17 show a liquid crystal display apparatus according to a sixth embodiment of the present invention, wherein FIG. 15 is a side view showing a cross section of a touch panel portion, FIG. 16 is a plan view showing the touch panel and FIG. 17 is a schematic block diagram showing the touched position coordinate detecting means. It is to be noted that, in this embodiment, like reference numerals denote members equal to those in the first embodiment, thereby eliminating their explanation.

A liquid crystal display apparatus according to this embodiment is provided with a liquid crystal display device displaying an image and a touch panel 300 constituted of one transparent electroconductive film 311 arranged on an observation side of the liquid crystal display device. A touch pen 330 touches an arbitrary position on the electroconductive film 311. Touched position coordinate detecting means is provided as shown in FIG. 17.

As the liquid crystal display device, there is used a liquid crystal display device which is of a TN or STN type utilized in the first or fourth embodiment, a homeotropic alignment type, a homogeneous type, a bend alignment type or a transverse electric field type.

The electroconductive film 311 of the touch panel 300 is constituted of a transparent electroconductive film of, e.g., ITO having a predetermined resistance value, and formed on one entire surface of a transparent base substrate 310 formed of a resin film made of, e.g., optically isotropic glass, triacetyl cellulose, polycarbonate or polyether sulfone formed into a rectangular shape corresponding to an entire screen region of the liquid crystal display device.

First strip-like electrodes 312a and 312b formed of a low-resistance metal film are provided at both end edges of this electroconductive film 311 in one of two directions perpendicular to each other, e.g., a direction of a horizontal axis (which will be referred to as an X-axis hereinafter) of the screen of the liquid crystal display panel over the substantially entire length of each edge portion, and second strip-like electrodes 313a and 313b formed of a low-resistance metal film are provided at both end edges in the other direction, i.e., a direction of a vertical axis (which will be referred to as a Y-axis hereinafter) of the screen over the substantially entire length of each edge portion.

The first strip-like electrodes 312a and 312b and the second strip-like electrodes 313a and 313b are formed to avoid parts corresponding to corner portions of the electroconductive film 311 in such a manner that these electrodes are not directly short-circuited.

Additionally, the base substrate 310 is arranged on the observation side of the liquid crystal display device in such a manner that its surface on which the electroconductive film 311 is formed faces an observing direction, and an outer rim portion of the other surface of the base substrate 310 is attached to an observation-side surface of the liquid crystal display device (an outer surface of an observation-side polarizing plate 8) through a frame-like spacer 314 made of an adhesive double coated film or the like.

The touch pen 330 has a structure in which an electroconductive pen tip 330a made of a metal is provided at an end of an insulative pen main body formed of a resin pipe or the like, and the electroconductive pen tip 330a is connected with a flexible cord 330b led out from a rear end of the pen main body.

Further, the touched position coordinate detecting means is provided with a voltage application circuit which alternately applies a voltage having a fixed value between the first strip-like electrodes 312a and 312b and between the second strip-like electrodes 313a and 313b, voltage measuring means or a voltmeter 325 which measures a voltage at an arbitrary point on the electroconductive film 311 with which the electroconductive pen tip 330a of the touch pen 330 comes into contact, and coordinate detecting means 326 which detects a coordinate of the point on the electroconductive film 311 touched by the touch pen 330 based on a measured value of the voltage measuring means 325.

The voltage application circuit is provided with a constant voltage power supply or D.C. source 317 formed of a direct-current power supply, a first switch 320 which switches connection between one pole (a negative pole in the drawing) of this constant voltage power supply 317 and one first strip-like electrode 312a or one second strip-like electrode 313a, and a second switch 323 which switches connection between the other pole of the constant voltage power supply 317 and the other first strip-like electrode 312b or the other second strip-like electrode 313b.

In the voltage application circuit, the first and second switches 320 and 323 are switched between a side or position where the first strip-like electrodes 312a and 312b are connected with both poles of the constant voltage power supply 317 (a state shown in FIG. 17) and a side or position where the second strip-like electrodes 313a and 313b are connected with both poles of the constant voltage power supply 317 by non-illustrated controlling means in a preset period, e.g., a period of 0.1 seconds, and a voltage having a fixed value is alternately applied from the constant voltage power supply 317 between both ends of the electroconductive film 311 in the X-axis direction (between the strip-like electrodes 312a and 312b) and between both ends of the electroconductive film 311 in the Y-axis direction (between the strip-like electrodes 313a and 313b).

The coordinate detecting means 326 calculates a coordinate of the touched point on the electroconductive film 311 in the X-axis direction (which will be referred to as an X-coordinate) based on a measured value of the voltage measuring means 325 when the voltage applied between both ends of the electroconductive film 311 in the X-axis direction, and calculates a coordinate of the touched point on the electroconductive film 311 in the Y-axis direction (which will be referred to as a Y-coordinate) based on a measured value of the voltage measuring means 325 when the voltage is applied between both ends of the electroconductive film 311 in the Y-axis direction.

Detection of the X and Y-coordinates of the touched point based on the measured values of the voltage measuring means 325 is carried out by the following arithmetic operation.

Assuming that V₀ is a voltage value of the constant voltage power supply 317, 0 is an X-coordinate value at one end of the electroconductive film 311 in the X-axis direction (an inner edge of the strip-like electrode 312a), 1 is an X-coordinate value at the other end of the electroconductive film 311 in the X-axis direction (an inner edge of the strip-like electrode 312b), x is an X-coordinate of the touched point, rₓ is a resistance value between both ends of the electroconductive film 311 in the X-axis direction (between the inner edges of the strip-like electrodes 312a and 312b) and R is an internal resistance value of the voltmeter 325, rx<<R is achieved, and hence a measured voltage value V(x) of the voltmeter 325 when the touch pen 330 is brought into contact with a position of the X-coordinate x can be represented by the following expression:
V(x)=V₀(1−x)

Furthermore, assuming that 0 is a Y-coordinate value at one end of the electroconductive film 311 in the Y-axis direction (an inner edge of the strip-like electrode 313a), 1 is a Y-coordinate value at the other end of the electroconductive film 311 in the Y-axis direction (an inner edge of the strip-like electrode 313b), y is a Y-coordinate of the touched point, and r_{y} is a resistance value between both ends of the electroconductive film 311 in the Y-axis direction (between the inner edges of the strip-like electrodes 313a and 313b), r_{y}<<R is achieved, and hence a measured voltage value V(y) of the voltmeter 325 when the touch pen 330 is brought into contact with a position of the Y-coordinate y can be represented by the following expression:
V(y)=V₀(1−y)

Therefore, the X-coordinate x and the Y-coordinate y of the touched point can be calculated based on the following expressions:
x=1−V(x)/v₀
y=1−V(y)/v₀

That is, according to this liquid crystal display apparatus, the touch panel is formed of the single electroconductive film 311 arranged on the observation side of the liquid crystal display panel, the electroconductive film 311 is touched by the touch pen 330 having the electroconductive pen tip 330a, and a voltage at this touched position in the X-coordinate direction and a voltage at the same in the Y-coordinate direction are respectively measured. As a result, the X-coordinate and the Y-coordinate of the touched position can be detected.

Moreover, in this liquid crystal display apparatus, since the touch panel is formed of the single electroconductive film 311, the thickness of the touch panel can be reduced, thereby decreasing a thickness of the entire apparatus as compared with a display apparatus including a conventional touch panel.

Additionally, according to this liquid crystal display apparatus, the electroconductive film 311 is formed on one surface of the transparent base substrate 310, and the base substrate 310 is arranged on the observation side of the liquid crystal display device in such a manner that its surface on which the electroconductive film 311 is formed faces the observing direction. Therefore, a touch pressure locally applied to the electroconductive film 311 can be received by the base substrate 310, thus protecting the liquid crystal display device against the touch pressure.

Further, according to this liquid crystal display apparatus, since the outer rim portion of the other surface of the base substrate 310 is attached to the observation-side surface of the liquid crystal display device through the frame-like spacer 314, a gap corresponding to the thickness of the spacer 314 can be formed between the base substrate 310 and the liquid crystal display device. As a result, the liquid crystal display device can be further effectively protected against the touch pressure.

Although the above has described the embodiment in which the direct-current power supply is applied as the voltage power supply 317 which alternately applies a voltage having a fixed value between both ends of the electroconductive film 311 in one of two directions perpendicular to each other and between both ends of the same in the other direction, the constant voltage power supply may be an alternating-current power supply 417 like a modification shown in FIG. 18.

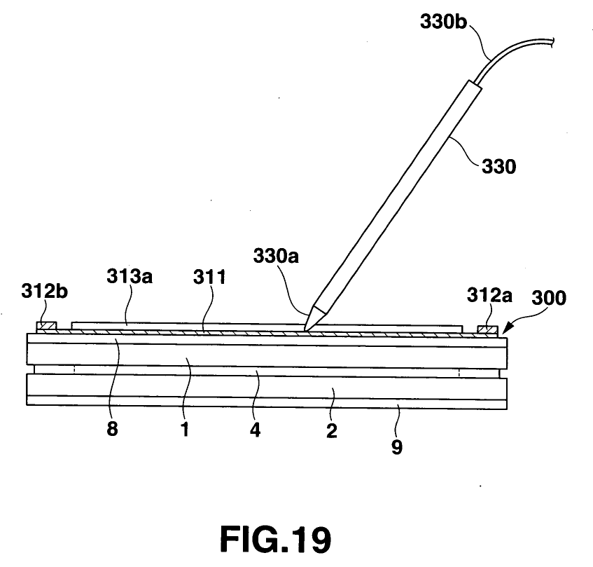

Furthermore, in this embodiment, as shown in FIG. 19, the base substrate 310 may be omitted and the electroconductive film 311 may be formed on the polarizing plate 8 arranged on the observation-side. In such a case, the supporting film supporting a polarizing layer of the polarizing plate 8 server as the base substrate 310, or that the liquid crystal display device can be sufficiently protected against the touch pressure.

Moreover, although the display apparatus according to the foregoing embodiment is a liquid crystal display apparatus including a liquid crystal display panel, the present invention can be likewise applied to a display apparatus including other display panels such as an electroluminescence display panel.

What is claimed is:

1. A liquid crystal display apparatus comprising:
a liquid crystal display device; and
a touch panel,
the liquid crystal display device including:
first and second substrates which are arranged to face each other with a gap therebetween, the first substrate being positioned on an observation side and the second substrate being positioned on an opposite side of the observation side where the first substrate is positioned;
a liquid crystal layer interposed between the first and second substrates;
a first electrode which is provided on one of opposed inner surface sides of the substrates, and a second electrode which is provided on an inner surface side of one of the first and second substrates and supplies a voltage between itself and the first electrode to apply an electric field to the liquid crystal layer; and
a pair of polarizing plates respectively arranged on the observation side and the opposite side on the other side of the substrates,
the touch panel having at least one first electroconductive film which is arranged on at least one of an outer surface of the substrate and the polarizing plate on the observation side in the liquid crystal display device and has a predetermined resistance value, and detecting a specified position on the first electroconductive film based on a voltage previously applied to the first electroconductive film and a voltage measured at the specified position.

2. The liquid crystal display apparatus according to claim 1, wherein the touch panel comprises: means for applying a predetermined voltage to the first electroconductive film; means for measuring a voltage at the specified position on the first electroconductive film; and position detecting means for detecting the specified position based on a value of the measured voltage.

3. The liquid crystal display device according to claim 1, wherein the touch panel is formed of a contact type touch panel adopting a resistance mode which includes a second electroconductive film arranged to face the first electroconductive film with a gap therebetween, and deforms the second electroconductive film by locally pushing the second electroconductive film from the observation side, whereby the pushed part of the second electroconductive film is locally brought into contact with the first electroconductive film.

4. The liquid crystal display apparatus according to claim 1, wherein the touch panel comprises: a second electroconductive film arranged to face the first electroconductive film with a gap therebetween; means for supplying a voltage to the first and second electroconductive films; means for measuring a voltage at the specified position on the first electroconductive film and a voltage at the specified position on the second electroconductive film, respectively; and means for detecting the specified position based on values of the plurality of measured voltages.

5. The liquid crystal display device according to claim 4, wherein the first electroconductive film of the touch panel is provided on an outer surface of the observation-side substrate in the liquid crystal display device.

6. The liquid crystal display apparatus according to claim 5, wherein the liquid crystal display device comprises an observation-side polarizing plate arranged on the observation side on the outer side of the substrates with a predetermined gap, and
the second electroconductive film of the touch panel is formed on a surface of the observation-side polarizing plate facing the observation-side substrate.

7. The liquid crystal display apparatus according to claim 5, wherein the liquid crystal display device further comprises an optical film having a phase plate which is arranged on the observation side of the observation-side substrate with a predetermined gap and optically compensates transmitted light, and the second electroconductive film of the touch panel is formed on a surface of the optical film facing the observation-side substrate.

8. The liquid crystal display apparatus according to claim 5, wherein the liquid crystal display device further comprises an optical film having of a phase plate which is arranged between the observation-side substrate and the observation-side polarizing plate and optically compensates transmitted light, and
the touch panel further comprises a transparent protection film which is arranged on the first electroconductive film provided on the observation side of the observation-side substrate in the liquid crystal display device with a predetermined gap therebetween and has the second electroconductive film formed on its surface facing the first electroconductive film.

9. The liquid crystal display apparatus according to claim 5, wherein the liquid crystal display device comprises at least two of first and second electrodes which are formed on the inner surface side of one of substrates facing each other and apply a voltage between themselves to apply an electric field in a direction substantially parallel to the surfaces of the substrates to the liquid crystal layer, and a third electrode which is provided on the inner surface of the other substrate and applies an electric field in a thickness direction of the liquid crystal layer between itself and at least one of the first electrode and the second electrode.

10. A liquid crystal display apparatus comprising:
a liquid crystal display device; and
a touch panel,
the liquid crystal display device having:
first and second substrates which are arranged to face each other with a gap therebetween, the first substrate being positioned on an observation side and the second substrate being positioned on an opposite side of the observation side where the first substrate is positioned;
a liquid crystal layer interposed between the first and second substrates;
a first electrode which is provided on one of opposed inner surfaces of the substrates, i.e., an inner surface of one substrate, and a second electrode which is provided on an inner surface of the one substrate or the other substrate and supplies a voltage between itself and the first electrode to apply an electric field to the liquid crystal layer; and
a pair of polarizing plates which are arranged on the observation side and the opposite side on the outer sides of the first and second substrates, respectively,
the touch panel having:
a first electroconductive film which is provided on an outer surface of the first substrate in the liquid crystal layer and has a predetermined resistance value;
a second electroconductive film which is arranged to face the first electroconductive film with a gap therebetween, partially deformed to come into contact with the first electroconductive film when a specified position in a region corresponding to the first electroconductive film is pushed, and has a predetermined resistance value, a voltage being supplied to the first and second electroconductive films; and
position detecting means for measuring a voltage at a position where the first electroconductive film and the second electroconductive film come into contact with each other, and detecting the contact position on the first electroconductive film based on the measured voltage.

11. The liquid crystal display apparatus according to claim 10, wherein the liquid crystal display device comprises an observation-side polarizing plate arranged on the observation side on the outer side of the first and second substrates with a predetermined gap, and
the second electroconductive film of the touch panel is provided on a surface of the observation-side polarizing plate facing the first substrate.

12. The liquid crystal display apparatus according to claim 10, wherein the liquid crystal display device further comprises a film-like optical element which is arranged on the observation side of the first substrate with a predetermined gap and optically compensates transmitted light, and the second electroconductive film of the touch panel is formed on a surface of the optical element facing the first substrate.

13. The liquid crystal display apparatus according to claim 12, wherein the optical element is formed of a phase plate which compensates the viewing angle dependence of a transmission factor of the liquid crystal display device.

14. The liquid crystal display apparatus according to claim 10, wherein the touch panel further comprises a transparent protection film which is arranged on the observation side of the first substrate of the liquid crystal display device with a predetermined gap, and
the second electroconductive film is formed on a surface of the protection film facing the first substrate.

15. The liquid crystal display apparatus according to claim 10, wherein the liquid crystal display device is a liquid crystal display device in which first and second electrodes which generate an electric field in a thickness direction of the liquid crystal layer are respectively formed on opposed inner surfaces of the first and second substrates and an inclination of liquid crystal molecules in the liquid crystal layer with respect to the substrate surfaces is controlled to control a transmission factor.

16. The liquid crystal display apparatus according to claim 10, wherein the liquid crystal display device is a transverse electric field type liquid crystal display device in which first and second electrodes which generate an electric field substantially parallel to surfaces of the first and second substrates are formed on one of opposed inner surfaces of the pair of substrates and an alignment direction of liquid crystal molecules in the liquid crystal layer is controlled within a plane parallel to the surfaces of the substrates to control a transmission factor.

17. The liquid crystal display apparatus according to claim 1, wherein the liquid crystal display device is a viewing angle control type liquid crystal display device in which a third electrode is formed on the other one of opposed inner surfaces of the first and second substrates and an electric field is generated between the third electrode and at least one of the first and second electrodes to obliquely align the liquid crystal molecules with respect to the surfaces of the substrates, thereby controlling a viewing angle of the liquid crystal display device.

18. A liquid crystal display apparatus comprising:
a liquid crystal display device; and
a touch panel,
the liquid crystal display device having:
first and second substrates which are arranged to face each other with a gap therebetween, the first substrate being positioned on an observation side and the second substrate being positioned on an opposite side of the observation side where the first substrate is positioned;
a liquid crystal layer interposed between the first and second substrates;
a first electrode provided on one of opposed inner surfaces of the first and second substrates, and a second electrode which is provided on an inner surface of the one substrate or the other substrate and supplies a voltage between itself and the first electrode to apply an electric field to the liquid crystal layer; and
a pair of polarizing plates respectively arranged on the observation side and the opposite side on the outer sides of the first and second substrates,
the touch panel having:
an electroconductive film which is arranged on the observation side of the liquid crystal display device and has a resistance value;
voltage applying means for supplying a voltage from both ends of the electroconductive film in one direction and both ends in the other direction crossing one direction;
means for specifying an arbitrary position on the electroconductive film; and
position detecting means for measuring a voltage at a position on the electroconductive film specified by the means for specifying the position, and detecting the specified position based on the measured voltage.

19. The liquid crystal display apparatus according to claim 18, wherein the touch panel comprises another electroconductive film formed on the observation side of a transparent film which is arranged on the observation side of the liquid crystal display device with a predetermined gap through a spacer.

20. The liquid crystal display apparatus according to claim 18, wherein the touch panel comprises another electroconductive film formed on the observation side of a transparent film closely arranged on the observation-side polarizing plate in the liquid crystal display device.
